(19) United States
(12) Patent Application Publication
(10) Pub. No.: US 2026/0287942 A1
(43) Pub. Date: Sep. 24, 2026

(54) CONTROLLABLE OPTICAL DEVICE

(71) Applicants: HYCOM CORE OY, Joensuu (FI); BRIGHTERWAVE OY, Tampere (FI)

(72) Inventors: Janne KONTTINEN, Tampere (FI); Seppo HONKANEN, Helsinki (FI)

(73) Assignees: HYCOM CORE OY, Joensuu (FI); BRIGHTERWAVE OY, Tampere (FI)

(21) Appl. No.: 19/473,035

(22) PCT Filed: Apr. 13, 2024
(86) PCT No.: PCT/FI2024/050172

§ 371 Date: Oct. 6, 2025

(30) Foreign Application Priority Data
Apr. 13, 2023 (FI) 20237069

(51) Int. Cl. G02F 1/035; G02F 1/35

(52) U.S. Cl. CPC G02F 1/035; G02F 1/3534

(57) ABSTRACT

Devices with electrically controllable optical functionality are described. The refractive index of a device is locally modified by introducing electric field which introduces or changes the optical functionality of the device operating at one or more wavelengths.

### CROSS-REFERENCE TO RELATED APPLICATIONS

This application is a U.S. National Stage application of PCT/FI2024/050172, filed Apr. 13, 2024 and published on Oct. 17, 2024, as WO 2024/213836, which claims the benefit of Finnish Patent Application No. 20237069, filed Apr. 13, 2023, all of which are hereby incorporated by reference in their entireties.

### FIELD OF THE INVENTION

The present invention relates to electrically controllable devices and methods of manipulating and monitoring properties thereof to introduce, change or monitor the functionality of devices guiding electromagnetic radiation.

### BACKGROUND TO THE INVENTION

It is known that specific materials lacking inversion symmetry, such as lithium niobate (LiNbO₃), lithium tantalate (LiTaO₃), potassium dihydrogenphosphate (KH₂PO₄, KDP), deuterated potassium dihydrogen phosphate (KD₂PO₄, DKDP, KD*P), specific polymer and glass materials can be susceptible to a Pockels effect, meaning directionally dependent linear variation in the refractive index, occurring in response to an applied electric field. For example, U.S. patent application publication No. 2004/0170351 A1 describes a waveguide modulator wherein electrodes are positioned adjacent to the optical waveguide to apply an electric field across an electro-optic region. The applied field alters the refractive index of the material and thereby modulates the phase or amplitude of the transmitted optical signal. The publication further discloses various waveguide configurations, electrode arrangements such as coplanar or traveling-wave structures, and fabrication methods that allow integration with semiconductor processes for high-speed optical communication applications.

On the other hand, some specific devices are utilizing other beneficial properties of these materials, such as birefringence, nonlinear polarization, piezoelectric or electro-optic properties in applications such as optical frequency conversion, polarization rotation, optical switching, optical filtering and optical coupling. For example, publication WO 2013/034813 A3 discloses a device for second-harmonic generation including a wavelength-converting portion configured to convert energy of incident (“first”) light into output (“second”) light at approximately twice the frequency (half the wavelength). The publication further discloses associated optical structures and arrangements for efficiently coupling the first light into the nonlinear medium and extracting the converted light, thereby enabling compact wavelength-conversion modules useful in laser systems and other photonic applications.

In particular, there is an emerging interest to utilize lithium niobate as a functional material in novel optical devices due to the recent commercial availability of high-quality thin-film lithium niobate (TFLN). This integrated photonic material platform enables tight mode confinement, improving the frequency-mixing efficiency by orders of magnitude while at the same time offering additional degrees of freedom for engineering the optical properties by using approaches such as dispersion engineering. Importantly, the large refractive index contrast of TFLN material enables realization of lithium niobate-based photonic integrated circuits on a wafer scale.

In many applications, several components may need to be cascaded one after another, which may cause undesired losses and deteriorating reflections to the optical signal. For example, waveguide Bragg gratings having periodic surface corrugation are commonly used in optical filtering. For example, patent application publication US 2018/0111244 A1 describes a waveguide Bragg grating implemented on a silicon substrate with a silicon dioxide cladding and a silicon-nitride core configured as a complex Bragg grating. The publication teaches designing the grating profile using layer-peeling/adding techniques and mapping the target effective-index variation to a one-layer waveguide structure with spatially varying width and/or thickness, thereby generating user-specified spectral responses (e.g., amplitude and phase) for optical filtering.

However, multiple Bragg gratings, designed for different wavelengths, may need to be cascaded, and processing of physical surface corrugations to materials such as lithium niobate may also be more challenging due to specific material structural properties. This may cause scattering losses to signals carried by wavelengths that are not intended to be affected by a specific grating or other wavelength-selective structure. Unwanted crosstalk between different channels may also occur. Furthermore, fine-tuning the operation of these physical gratings mat be difficult after fabrication.

### Purpose Of The Invention

The purpose of the invention is to provide a design and manufacturing method for fabrication of programmable, ultra-compact photonic integrated circuits which can be used in applications such as frequency-conversion, high-speed optoelectronic devices and devices operating at multiple wavelengths, guided modes, polarization, phase and/or optical power level modulation states. A few examples of important programmable devices are multi-port optical switches and reconfigurable add-drop wavelength multi/demultiplexers, in which high speed operation is desired.

### Description of the Invention

Optical components with controllable or programmable optical properties can be particularly useful in devices where it is beneficial to alter the optical functionality of the device. Specific applications where the controllable optical properties could be useful include nonlinear optical devices, optical filters, couplers, mirrors and anti-reflective structures, elements varying the polarization state or phase of an optical field, elements changing the direction of propagation of the light, optical cavity/Fabry-Pérot etalon structures, optical mode conversion structures and structures coupling an electromagnetic radiation in an/or out of a device.

A thin film (TF) of Lithium Niobate (LN, TFLN) or other material exhibiting Pockels effect (108) is bonded directly or with a waveguiding intermediate layer (111) on a silicon or other substrate (105)/supporting material with an array of contacted sections (120) for applying an electric field (130) across the material exhibiting Pockels effect (108) with electrical contacts (121a . . . n) patterned on one or both sides of the thin film of material exhibiting Pockels effect (108). Between the electrical contacts (121, 121a . . . n) there may be one or more electrically insulating materials (122) to isolate the electrical contacts from each other. An electric field may be applied on part or whole of the material exhibiting Pockels effect (108) in order to change the optical properties of the material exhibiting Pockels effect (108) in order to introduce or alter optical guiding structures, optical coupling structures, optical filter structures such as distributed Bragg grating sections, polarization rotation structures, mode conversion structures or any combination of the aforementioned in combination with the other waveguiding materials the controllable optical device (100) may comprise. There may be at least one or more voltage sources (125) to introduce at least one static or alternating electric field. Several advantages can be foreseen; i) due to the inherently fast Pockels effect the optical functionality of the devices can be tuned with very high speed, ii) the required electrical voltage for tuning is low due to the close proximity of the electrical contacts on the two sides of the material exhibiting Pockels effect (108), iii) fine-tuning of the device operation after fabrication can be achieved, and iv) the added losses for other wavelengths, e.g., in optical filtering can be negligible since the volume gratings (115) formed by Pockels effect feature ultra-smooth interfaces.

In addition, the strength of the Pockels effect, i.e. the refractive index at specific regions of the controllable optical device (100) can be selected by controlling the applied voltage and the direction of the induced electric field. The change of the refractive index can be selected to target operation at specific wavelength, in addition to controlling the wavelength span over which the controllable optical device (100) may operate.

### LIST OF THE FIGURES

In the following, the invention is presented in detail by referring to the attached drawings, where:

FIG. 1 shows a controllable optical device (100) with waveguide (110) comprising material exhibiting Pockels effect (108) guiding at least one optical mode (112) and electrical contacts (121a, 121b, 121c) for applying an electric field (130). The electrical contacts (121a . . . n) are arranged in a section of contacts (120) with two (2) interleaved patterns of electrical contacts (121b, 121c) shown as 1 and 2 and separated with electrically insulating material (122).

FIG. 2 shows a controllable optical device (100) with waveguide (110) comprising material exhibiting Pockels effect (108) guiding at least one optical mode (112) by introducing at least one waveguiding intermediate layer (111) and electrical contacts (121a, 121b, 121c) for applying an electric field (130). The electrical contacts (121a . . . n) are arranged in a section of contacts (120) with two (2) interleaved patterns of electrical contacts (121b, 121c) shown as 1 and 2 and separated with electrically insulating material (122). An electrical voltage from a voltage source (125) may be applied between at least two electrical contacts (121a . . . n) to cause a refractive index change in the material (108) via Pockels effect in regions affected by the applied electric field (130). The waveguiding intermediate layer (111) may comprise at least one material on the substrate (105).

FIG. 3 shows a controllable optical device (100) with waveguide (110) comprising material exhibiting Pockels effect (108) guiding at least one optical mode (112) and electrical contacts (121a, 121b, 121c) for applying an electricfield (130). The electrical contacts (121a . . . n) are arranged in a section of contacts (120) with two (2) interleaved patterns of electrical contacts (121b, 121c) shown as 1 and 2 and separated with electrically insulating material (122). An electrical voltage from a voltage source (125) is applied between at least two electrical contacts (121a . . . n) to cause a refractive index change in the material (108) via Pockels effect in regions affected by the applied electric field (130).

FIG. 4 shows a controllable optical device (100) with waveguide (110) comprising material exhibiting Pockels effect (108) guiding at least one optical mode (112) comprising at least one wavelength (λ1 . . . λn) coupled to an input waveguide. After an adiabatic and asymmetric y-branch coupler (116), each light channel is reflected by its own tilted grating (115), which acts also as a mode converter. Therefore, after reflection, all the channels are coupled to the narrower port of the y-branch (no circulator is needed).

FIG. 5 shows a controllable optical device (100) with additional y-branches between the gratings (115), each channel can be coupled to its own output port (Note: all the wavelengths in the same output, or in their own output ports, or anything in between is possible).

FIG. 6 shows a controllable optical device (100) where light at multiple wavelengths is coupled to an input waveguide (110). After an adiabatic and asymmetric y-branch coupler (116), light is split e.g. 50/50 by a symmetric y-branch. Each light channel is reflected by its own grating (on the two channels). Due to a π/2 phase shifter on the upper arm all the channels are coupled, after reflection, to the narrower port of the y-branch (no circulator is needed). Additional phase shifters (117) may be used between the gratings (115) if the wavelengths are not close to each other.

FIG. 7 shows a controllable optical device (100) comprising an electrically contacted section (120) of electrical contacts (121a, 121b and 121c) where an electrical field (130) may be used to introduce a wavelength-locking reflection from a in at least one wavelength λ1 and at least one periodically poled section (135) comprising at least one domain inversion (136) for providing sum-frequency generation in at least one output wavelength λ2.

FIG. 8 shows a controllable optical device (100) comprising two waveguides (110) where at least one of the waveguides (110) is used for wavelength locking via tunable volume grating (115) and at least one of the waveguides (110) is used for sum-frequency generation. Refractive index and thus the functionality of at least one of the waveguides (110) can be controlled by applied electric field (130) via electrical contacts (121a . . . n).

FIG. 9 shows a controllable optical device (100) where also the frequency-conversion section (135) can be electrically tuned using a Pockels effect via introduced electrical field (130) between electrical contacts (121a and 121e).

FIG. 10 shows a controllable optical device (100) where at least one of the electrical contacts (121a . . . n) is provided through the layer stack (109) to introduce a Pockels effect and controlled by an attached active carrier/substrate (105)
FIG. 11 shows a controllable optical device (100) where light at multiple wavelengths is coupled to an input waveguide (110). After an adiabatic and asymmetric y-branch coupler (116), the light channels, for which the programmable and mode converting grating (115) (or a grating section) is turned on, are reflected and coupled to the narrower port of the y-branch coupler (116). Similarly, these wavelength channels may be added to the data stream from the other side of the device.

### DETAILED DESCRIPTION OF THE INVENTION

The current invention overcomes the limitations of the prior art by providing a method to effectively introduce optical functionality in optical devices via Pockels effect. The electric field across the material exhibiting the Pockels effect (108), and thus the achieved change in the refractive index as a function of the applied electrical voltage, is enhanced by utilizing substantially optically transparent electrical contacts (121a . . . n), allowing introduction of the electric field (130) with narrowed spacing between the electrical contacts (121a . . . n) without introducing excessive optical losses for the guided optical mode(s) (112).

In accordance with the first aspect of the present invention, as shown in FIG. 1, there is a layer thin film of material exhibiting Pockels effect (108) sandwiched between at least two substantially transparent layers, and the sandwich structure is guiding at least one optical mode (112).

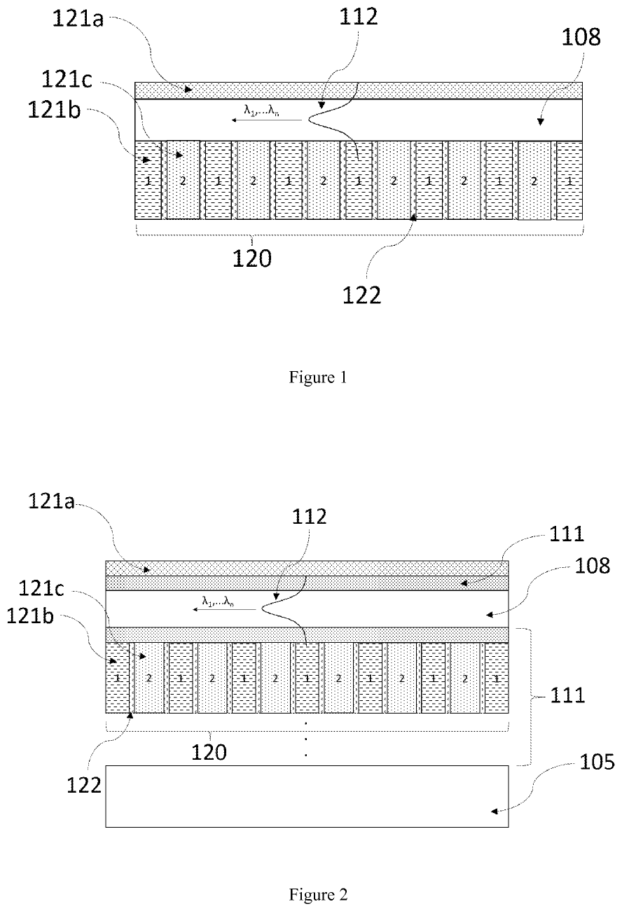

In accordance with the second aspect of the present invention, as illustrated in FIG. 2, the structure may include at least one additional, substantially transparent waveguiding intermediate layer (111) next to the layer of material exhibiting Pockels effect (108), at least on one side of the structure.

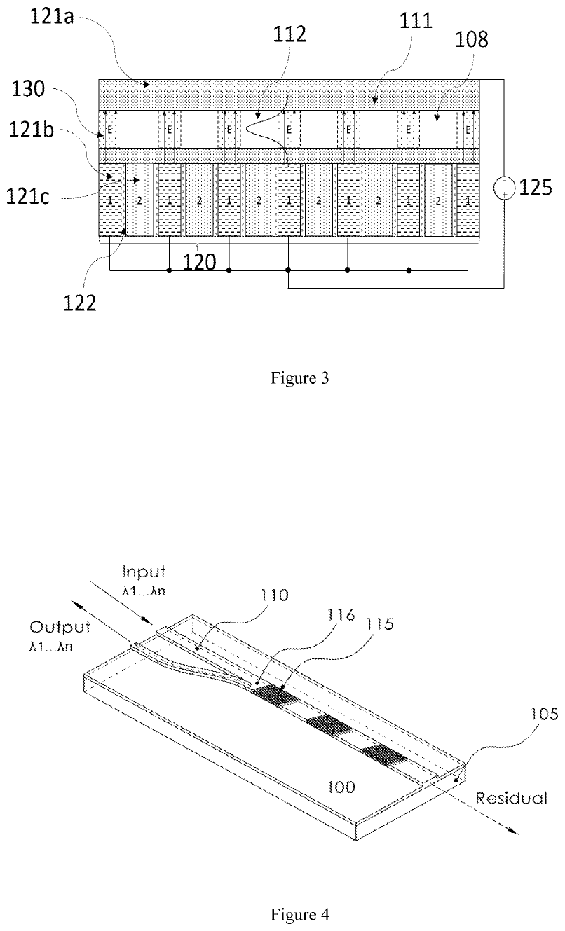

In accordance with the third aspect of the present invention, shown in FIG. 3, electrical contacts (121a . . . n) may be applied to create an electric field (130) in the device with a waveguide comprising material exhibiting Pockels effect (108). An electrical voltage may be applied between a ground contact (121a) and the patterned positive terminals “1” to cause a refractive index change in the material (108) via Pockels effect in regions affected by the applied electric field (130).

In accordance with the fourth aspect of the present invention, as illustrated in FIG. 4, light at one or more wavelengths may be coupled to a device (100) comprising an input waveguide (110), a coupler (116), and at least one grating element (115), as shown in FIG. 4, with substantially periodically patterned positive electrode configuration (grating element (115)). After reflection from one or more grating elements, light is coupled to the output waveguide (110) (narrow waveguide in FIG. 4). This may be achieved, e.g., by using an asymmetric coupler (116) and a tilted or an antisymmetric grating element (115).

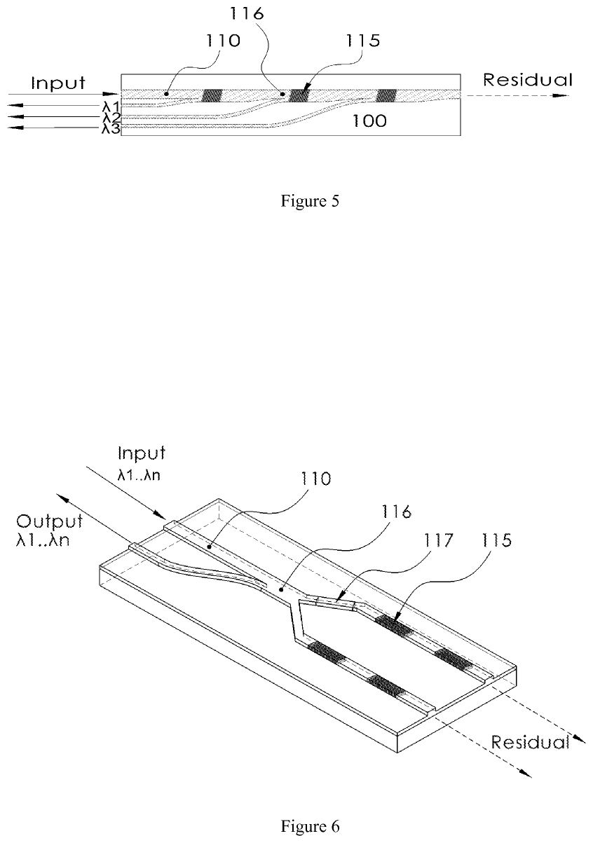

In accordance with the fifth aspect of the present invention, as shown in FIG. 5, several grating elements (115) may be cascaded with each of them operating at a different wavelength or a set of wavelengths. Light that is not reflected (residual light) may be dumped or used for monitoring purposes. For achieving this, e.g., a tilted waveguide end-facet (105), an antireflection coating or end-facet roughening may be used. As illustrated in FIG. 5, additional couplers (116) may be added between the grating elements (115), and each wavelength or a set of wavelengths may be coupled to its own output port. All the wavelengths may be coupled in the same output port or in their own output ports, or anything in between.

In accordance with the sixth aspect of the present invention, since light propagates the same way in two opposite directions, the input waveguide (110) in FIGS. 4 and 5 may be changed to an output waveguide and the output waveguides to input waveguides.

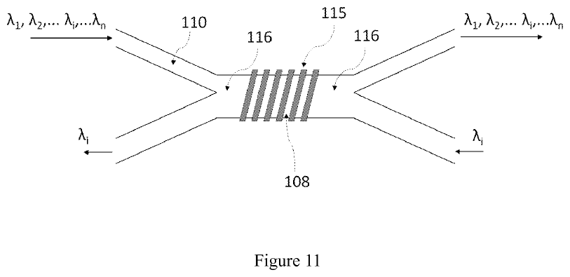

In accordance with the seventh aspect of the present invention, as described above and illustrated in FIGS. 4 and 5, different wavelengths may be switched, at very high speed, to any of the output ports. Different sections of a grating element (115) may be turned on when switching of a given wavelength (or a set of wavelengths) to a given output port is required. In accordance with the eighth aspect of the present invention, as shown in FIG. 11, one or more wavelengths may be dropped, in a fast reconfigurable manner, from a data stream containing multiple wavelengths. Similarly, one or more wavelengths may be added to the data stream by adding one or more ports to the other side of the photonic circuit (see also D2007 illustrating a passive add-drop wavelength multi/demultiplexer for a single wavelength operation).

In accordance with ninth aspect of the present invention, as illustrated in FIG. 6, light at multiple wavelengths is coupled to a device comprising an input waveguide (110), a coupler (116) with at least four ports, and at least two waveguide elements (115), as shown in FIG. 3, with substantially periodically patterned positive electrode configuration (grating element) (115). After reflection from two or more grating elements, light is coupled to the output waveguide (narrow waveguide in FIG. 6). This may be achieved, e.g., by using an asymmetric 4-port coupler (116) and two grating elements (115) resulting in approximately 180-degree phase difference between reflected light from the two waveguides with grating elements. The required phase difference may be achieved with an additional waveguide section in one arm (117), which, in addition, may be tuned via Pockels effect. This feature may be used for obtaining the required phase difference and for fine-tuning the phase difference.

In accordance with the tenth aspect of the present invention, several 4-port couplers and grating elements shown in FIG. 6 may cascaded (in a similar way as shown in FIGS. 4 and 5), with each of them operating at a different wavelength or a set of wavelengths. All the wavelengths may be coupled in the same output port or in their own output ports, or anything in between.

In accordance with the eleventh aspect of the present invention, light that is not reflected (residual light), as shown in FIGS. 4-6 , may be dumped or used for monitoring purposes (not shown). For achieving this, e.g., a tilted waveguide end-facet, an antireflection coating or end-facet roughening may be used.

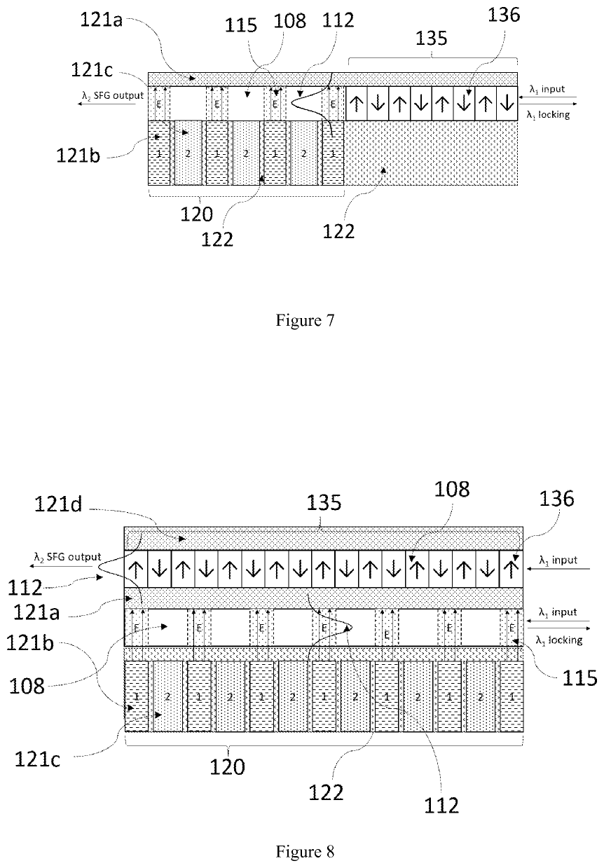

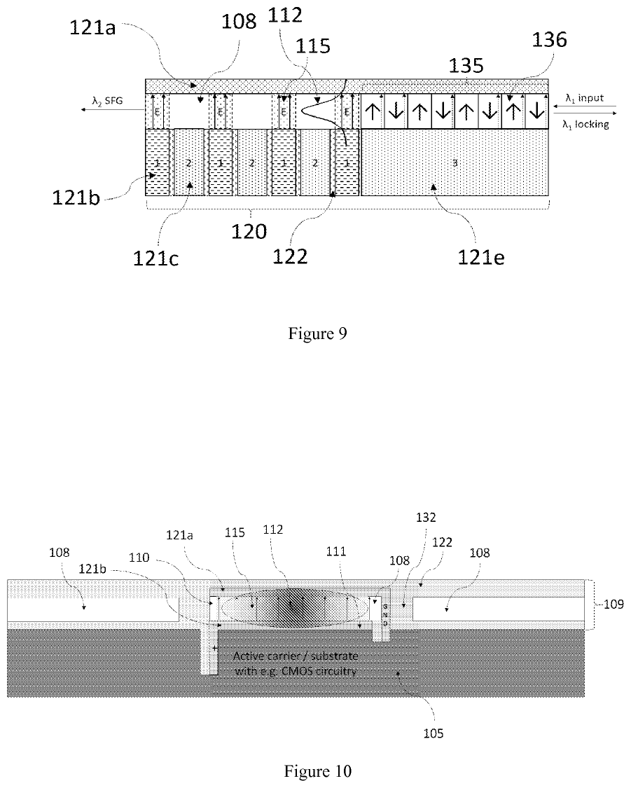

In accordance with the twelfth aspect of the present invention, in combination with any of the devices illustrated in FIGS. 1-11 , a tilted waveguide end-facet, specific reflective coating, an out-coupling grating or any combination of the preceding may be used to illuminate detector elements for monitoring of power level in different waveguides (110) (illustration not shown).

In accordance with the thirteenth aspect of the present invention, since light propagates the same way in two opposite directions, the input waveguide, shown in FIGS. 4-6 , may be changed to an output waveguide and the output waveguides to input waveguides.

In accordance with the fourteenth aspect of the present invention, a grating element described in FIGS. 1-11 may be used to split un-polarized light into quasi-TE polarized and quasi-TM polarized light, as the grating elements may be polarization sensitive (illustration not shown).

In accordance with the fifteenth aspect of the present invention, any of the devices described in FIGS. 1-11 may operate predominantly at a quasi-TE polarized or at a quasi-TM polarized waveguide mode.

In accordance with the sixteenth aspect of the present invention, any waveguide section of the devices described in FIGS. 1-11 may be tuned or modified by using the Pockels effect.

1. A controllable optical device comprising
a layer stack comprising at least two materials,
at least two electrical contacts,
wherein the said at least two materials in the said layer stack are substantially optically transparent in at least one operation wavelength of the device, at least one of the said at least two electrical contacts comprises material which is substantially optically transparent in at least one operation wavelength of the device and is electrically conductive, at least one of the said at least two materials in said layer stack is exhibiting Pockels effect which is used to introduce an optical function in the said controllable optical device by applying an electric field across the said at least one material in said layer stack exhibiting Pockels effect along at least one direction, and wherein the controllable optical device further comprises at least one periodically poled section comprising at least one domain inversion providing sum-frequency generation in at least one output wavelength, characterized in that the device further comprises an adiabatic and asymmetric y-branch coupler further comprising tilted grating for each channel for reflecting light, wherein the tilted grating further acts as a mode converter, and wherein all channels are coupled to the narrower port of the y-branch after reflection.

2. A controllable optical device according to patent claim 1, characterized in that said electrical contacts are on opposite sides of the said at least one layer of material exhibiting Pockels effect.

3. A controllable optical device according to claim 1, characterized in that the device further comprises a substrate with patterned contacts for electrical contacting of the electrical contacts, wherein the layer stack comprising at least two substantially optically transparent materials is in direct contact with the carrier/substrate.

4. A controllable optical device according to claim 1, characterized in that the said introduced optical function is any combination of the following: At least one distributed Bragg reflector, at least one section exhibiting frequency-conversion, at least one optical coupler, at least one polarization rotation, at least one in-or outcoupling function, at least one section used for introducing a difference in optical path length, at least one mode converter, at least one add/drop filter.

5. (canceled)

6. A controllable optical device according to claim 1, characterized in that at least one of the electrical contacts is contacted through at least one of two-materials of the layer stack.

7. A controllable optical device according to claim 1, characterized in that the device further comprises at least one waveguide guiding at least one optical mode and at least one electronically controllable or induced volume Bragg grating.

8. A controllable optical device according to claim 7, characterized in that reflection and/or transmission of at least one of the optical wavelengths of light propagating in the waveguide can be changed by altering electric field across the material exhibiting Pockels effect.

9. A controllable optical device according to claim 7, characterized in that at least one of the said waveguides exhibits frequency-conversion in at least one wavelength.

10. A controllable optical device according to claim 7, characterized in that at least one of the said waveguides exhibits frequency-conversion in at least one wavelength and at least part of at least one of the said waveguides is electrically controllable by changing the refractive index of at least one material in said at least one layer stack via Pockels effect.

11. A controllable optical device according to claim 7, characterized in that the said electronically controllable or induced volume Bragg grating is used to control the output spectrum of a light emitting device optically coupled with the controllable optical device.

12. A controllable optical device according to claim 7, characterized in that the said electronically controllable or induced volume Bragg grating is used to control the output spectrum of a light emitting device optically coupled with the controllable optical device in order to change the frequency-conversion efficiency in said least one waveguide in at least one wavelength.

13. A controllable optical device according to claim 7, characterized in that the said electronically controllable or induced volume Bragg grating is used to control the output spectrum of a light emitting device optically coupled with the controllable optical device in order to change the frequency-conversion efficiency in said least one waveguide in at least one wavelength, the controllable optical device further comprising electrical contacts for applying electric field across at least one part of at least one waveguide having at least one periodically poled section comprising at least one domain inversion region in order to change the frequency-conversion efficiency in said at least one waveguide in at least one wavelength.

14. A controllable optical device according to claim 1, characterized in that at least one wavelength is coupled in the input waveguide and at least one or none of the wavelengths is dropped to an output port, and at least one or none of the wavelengths is added using another input port, by applying an electric field across at least one section of at least one waveguide using a grating element.

15. A controllable optical device according to claim 1, characterized in that at least one wavelength is coupled to input ports and by applying an electric field across at least one section of at least one waveguide by electrical contacts using at least one grating element at least one wavelength is coupled in or out via at least one optical port.
